(19) United States
(12) Patent Application Publication
(10) Pub. No.: US 2025/0100372 A1
(43) Pub. Date: Mar. 27, 2025

(54) CONTROL DEVICE, MOVING OBJECT, ABNORMALITY DETECTION METHOD, AND NON-TRANSITORY TANGIBLE STORAGE MEDIUM

(71) Applicant: HONDA MOTOR CO., LTD., TOKYO (JP)

(72) Inventors: Satoru KAWASE, WAKO-SHI (JP); Kazuyuki KADOWAKI, WAKO-SHI (JP); Tsubasa NISHIOKA, WAKO-SHI (JP)

(21) Appl. No.: 18/887,208

(22) Filed: Sep. 17, 2024

(30) Foreign Application Priority Data
Sep. 21, 2023 (JP) 2023-154041

(51) Int. Cl. B60K 15/03

(52) U.S. Cl. CPC B60K 15/03; B60K 2015/0319; B60K 2015/03256

(57) ABSTRACT

A control device according to the present disclosure includes: an on-off valve control unit that executes control for closing an on-off valve provided between a fuel tank and a second fuel flow path in a case where a fuel is supplied from a first fuel flow path to the fuel tank; and a determination unit that determines the presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed.

### CROSS-REFERENCE TO RELATED APPLICATIONS

This application is based upon and claims the benefit of priority from Japanese Patent Application No. 2023-154041 filed on Sep. 21, 2023, the contents of which are incorporated herein by reference.

### BACKGROUND OF THE INVENTION

### Field of the Invention

The present disclosure relates to a control device, a moving object, an abnormality detection method, and a non-transitory tangible storage medium.

### Description of the Related Art

JP 7135986 B2 discloses a fuel cell system. The fuel cell system includes a filling side check valve that is an on-off valve for preventing backflow of hydrogen (fuel), and a determination unit that determines whether or not the filling side check valve is stuck (fails) in an open state.

### SUMMARY OF THE INVENTION

There has been a demand for techniques capable of detecting an abnormality of an on-off valve more satisfactorily.

The present invention has the object of solving the aforementioned problem.

According to a first aspect of the present invention, there is provided a control device of a fuel supply system, the fuel supply system including: a fuel tank configured to store a fuel supplied from a first fuel flow path; and an on-off valve provided between the fuel tank and a second fuel flow path configured to supply the fuel to a supply destination system of the fuel that consumes the fuel stored in the fuel tank, the control device comprising: an on-off valve control unit configured to execute control for closing the on-off valve in a case where the fuel is supplied from the first fuel flow path to the fuel tank; and a determination unit configured to determine presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed.

According to a second aspect of the present invention, there is provided a moving object comprising the above-described control device and the above-described fuel supply system.

According to a third aspect of the present invention, there is provided an abnormality detection method for detecting an abnormality of a fuel supply system, the abnormality detection method being executed by a computer, the fuel supply system including: a fuel tank configured to store a fuel supplied from a first fuel flow path; and an on-off valve provided between the fuel tank and a second fuel flow path configured to supply the fuel to a supply destination system of the fuel that consumes the fuel stored in the fuel tank, the abnormality detection method comprising: an on-off valve control step of executing control for closing the on-off valve in a case where the fuel is supplied from the first fuel flow path to the fuel tank; and a determination step of determining presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed.

According to a fourth aspect of the present invention, there is provided a program for causing the computer to execute the above-described abnormality detection method.

The present invention can detect an abnormality of the on-off valve more satisfactorily.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a system configuration diagram of a fuel supply system provided in a moving object according to an embodiment;

FIG. 2 is a block diagram of a control device;

FIG. 3 is a graph showing a change in fuel pressure in a second fuel flow path in a case where an on-off valve is normal;

FIG. 4 is a graph showing a change in the fuel pressure in the second fuel flow path in a case where the on-off valve is abnormal; and

FIG. 5 is a flowchart illustrating an abnormality detection method.

### DETAILED DESCRIPTION OF THE INVENTION

Regarding a method for detecting an abnormality of an on-off valve, the fuel cell system of JP 7135986 B2 has at least the following problem. Specifically, according to JP 7135986 B2, fuel is consumed to determine the presence or absence of an abnormality of the on-off valve.

### Embodiment

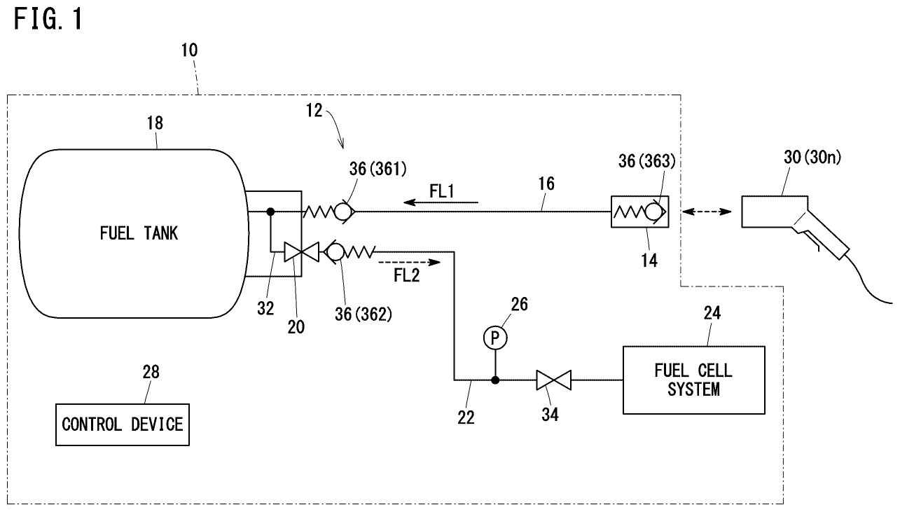

FIG. 1 is a system configuration diagram of a fuel supply system 12 provided in a moving object 10 according to an embodiment.

The moving object 10 is, for example, a vehicle such as a fuel cell vehicle (FCV). As shown in FIG. 1, the moving object 10 includes the fuel supply system 12. The fuel supply system 12 includes a filling unit 14, a first fuel flow path 16, a fuel tank 18, an on-off valve 20, a second fuel flow path 22, a fuel cell system 24, a sensor (pressure sensor) 26, and a control device 28.

The filling unit 14 includes a connector (not shown) connected to a fuel supply device 30. The fuel supply device 30 is a device that supplies a fuel to the moving object 10. More specifically, the fuel supply device 30 is a device that supplies a fuel to the fuel supply system 12 provided in the moving object 10. The fuel supply device 30 is a device provided outside the moving object 10. For example, FCVs consume hydrogen as a fuel. In this case, the fuel supply device 30 may include a nozzle 30n that is connectable to the connector and is capable of discharging hydrogen (hydrogen gas). The fuel supply device 30 is installed in, for example, a hydrogen station.

The first fuel flow path 16 includes, for example, a pipe member that connects the filling unit 14 and the fuel tank 18. The fuel is supplied to the first fuel flow path 16 from the fuel supply device 30 connected to the filling unit 14. The fuel supplied to the first fuel flow path 16 via the filling unit 14 flows toward the fuel tank 18 (an arrow FL1 in FIG. 1).

The fuel tank 18 stores the fuel supplied through the first fuel flow path 16. Further, the fuel tank 18 communicates, via the on-off valve 20, with the second fuel flow path 22 different from the first fuel flow path 16.

The on-off valve 20 is a shut-off valve that can be opened and closed. In a case where the on-off valve 20 is in an open state, fuel supply from the fuel tank 18 to the second fuel flow path 22 is permitted (an arrow FL2 in FIG. 1). In contrast, in a case where the on-off valve 20 is in a closed state, the fuel supply from the fuel tank 18 to the second fuel flow path 22 is restricted (cut off). The opening and closing control of the on-off valve 20 can be appropriately executed by the control device 28 provided in the vehicle. The control device 28 will be described in more detail later.

The second fuel flow path 22 is formed of, for example, a part of a pipe member that connects the on-off valve 20 and the fuel cell system 24. The second fuel flow path 22 communicates with the fuel tank 18 via a second check valve 362 described later. The second fuel flow path 22 can be supplied with the fuel from the fuel tank 18. More specifically, in a case where the on-off valve 20 is in the open state, the fuel can be supplied from the fuel tank 18 to the second fuel flow path 22. The fuel supplied to the second fuel flow path 22 flows toward the fuel cell system 24. It should be noted that, as shown in FIG. 1, the fuel supply system 12 may further include a third fuel flow path 32 that connects the on-off valve 20 and the first fuel flow path 16. In this case, the fuel tank 18 and the on-off valve 20 are connected to each other via the third fuel flow path 32 and a part of the first fuel flow path 16. The third fuel flow path 32 may be provided in the fuel tank 18.

The fuel cell system 24 is a supply destination of the fuel (hydrogen) stored in the fuel tank 18. The fuel cell system 24 consumes the fuel supplied from the fuel tank 18 and outputs electric power for driving the moving object 10. The fuel cell system 24 provided in a vehicle such as an FCV includes, for example, a fuel cell stack (not shown). The fuel cell stack generates electric power using hydrogen. An electric motor provided in the vehicle drives wheels and the like of the moving object 10 using the electric power output from the fuel cell system 24. It should be noted that the supply destination of the fuel is not limited to the fuel cell system 24. That is, the form of the supply destination of the fuel can be appropriately changed according to the type of the fuel.

The pressure sensor 26 is a sensor that outputs a detection signal corresponding to a fuel pressure that is the pressure of the fuel. The pressure sensor 26 is provided in the second fuel flow path 22. Therefore, the pressure sensor 26 outputs a detection signal corresponding to the fuel pressure in the second fuel flow path 22. The detection signal is input to the control device 28. It should be noted that, as shown in FIG. 1, the second fuel flow path 22 may further include a regulator 34. The regulator 34 reduces and stabilizes the fuel pressure. As a result, the load applied to the fuel cell system 24 is stabilized. The pressure sensor 26 may be provided between the on-off valve 20 and the regulator 34, but the present invention is not limited thereto.

The fuel supply system 12 may further include a plurality of check valves 36 (361 to 363). The plurality of check valves 36 include, for example, a first check valve 361, the second check valve 362, and a third check valve 363, which will be described next. The first check valve 361 is provided in the first fuel flow path 16 or the fuel tank 18. The first check valve 361 prevents the fuel from flowing back from the fuel tank 18 toward the first fuel flow path 16. The second check valve 362 is provided in the second fuel flow path 22. The second check valve 362 prevents the fuel from flowing back from the fuel cell system 24 (the second fuel flow path 22) toward the on-off valve 20. As shown in FIG. 1, the second check valve 362 is preferably provided between the on-off valve 20 and the pressure sensor 26. The third check valve 363 is provided in the filling unit 14. The third check valve 363 prevents the fuel from flowing back from the filling unit 14 toward the fuel supply device 30.

Although not shown in the drawings, the fuel supply system 12 may further include a sensor for detecting the fuel pressure in the first fuel flow path 16, and a sensor for detecting the temperature in the fuel tank 18.

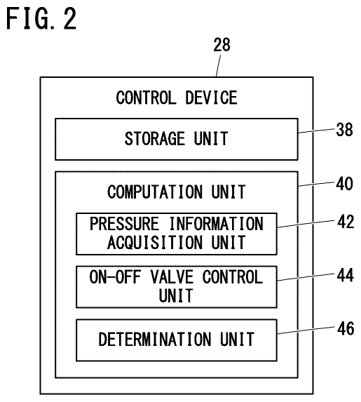

FIG. 2 is a block diagram of the control device 28.

The control device 28 is a computer (processing circuitry) that controls the fuel supply system 12. The control device 28 is, for example, an electronic control unit (ECU). As shown in FIG. 2, the control device 28 may include a storage unit 38 and a computation unit 40.

The storage unit 38 includes one or more memories (not shown). More specifically, the storage unit 38 includes, for example, a non-volatile memory such as a read only memory (ROM), a flash memory, or a magnetic disk, and a volatile memory such as a random access memory (RAM). The non-volatile memory stores, for example, a computer-executable program. The volatile memory stores, for example, data or the like that is temporarily necessary when a processor (the computation unit 40) described below performs computation based on a program.

The computation unit 40 includes a processor (not shown) such as a central processing unit (CPU) or a graphics processing unit (GPU). The computation unit 40 may include one or more processors. At least a part of the computation unit 40 may be realized by a predetermined integrated circuit such as an application specific integrated circuit (ASIC) or a field-programmable gate array (FPGA).

The computation unit 40 includes a pressure information acquisition unit 42, an on-off valve control unit 44, and a determination unit 46. The pressure information acquisition unit 42, the on-off valve control unit 44, and the determination unit 46 are realized by the computation unit 40 (the processor) executing a program stored in the storage unit 38 (the memory). At least a part of the pressure information acquisition unit 42, the on-off valve control unit 44, and the determination unit 46 may be realized by the above-described integrated circuit such as the ASIC or the FPGA.

The pressure information acquisition unit 42 acquires information indicating the fuel pressure based on the detection signal output from the pressure sensor 26. As described above, the pressure sensor 26 is provided in the second fuel flow path 22. Therefore, the pressure information acquisition unit 42 can acquire information indicating the fuel pressure in the second fuel flow path 22. The pressure sensor 26 can sequentially output detection signals corresponding to the fuel pressure. Therefore, the pressure information acquisition unit 42 can sequentially acquire information indicating the fuel pressure in the second fuel flow path 22.

The on-off valve control unit 44 executes control for closing the on-off valve 20. For example, in a case where the nozzle 30n is connected to the filling unit 14, the on-off valve control unit 44 outputs a closing control signal, which is a control signal for closing the on-off valve 20, to the on-off valve 20. The on-off valve 20 transitions to the closed state in response to the closing control signal. Further, for example, in a case where the filling unit 14 and the nozzle 30n are disconnected from each other, the on-off valve control unit 44 may output an opening control signal, which is a control signal for opening the on-off valve 20, to the on-off valve 20. The on-off valve 20 transitions to the open state in response to the opening control signal.

The determination unit 46 determines whether or not the fuel is being supplied from the first fuel flow path 16 to the fuel tank 18 in a state where the control for closing the on-off valve 20 is being executed. As described above, the first fuel flow path 16 may include the sensor (not shown) for detecting the fuel pressure in the first fuel flow path 16. In this case, the determination unit 46 may acquire information indicating the fuel pressure in the first fuel flow path 16 based on a detection signal of this sensor. Consequently, the determination unit 46 can determine whether or not the fuel is being supplied from the first fuel flow path 16 to the fuel tank 18 based on the information indicating the fuel pressure in the first fuel flow path 16.

In a case where the fuel is being supplied from the first fuel flow path 16 to the fuel tank 18 in a state where the control for closing the on-off valve 20 is being executed, the determination unit 46 executes the determination described next. Specifically, the determination unit 46 determines whether or not the on-off valve 20 is stuck in the open state, based on whether or not the fuel pressure in the second fuel flow path 22 excessively increases.

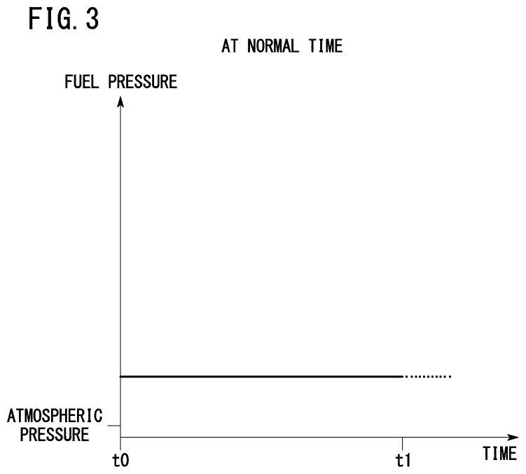

FIG. 3 is a graph showing a change in the fuel pressure in the second fuel flow path 22 in a case where the on-off valve 20 is normal. The vertical axis of FIG. 3 indicates the fuel pressure. The horizontal axis of FIG. 3 is a time axis.

As described above, in a case where the on-off valve 20 is in the closed state, the fuel supply from the fuel tank 18 to the second fuel flow path 22 is restricted. Therefore, if the on-off valve 20 is in the closed state when the fuel supply from the first fuel flow path 16 to the fuel tank 18 is started, the fuel pressure in the second fuel flow path 22 does not increase during the fuel supply from the first fuel flow path 16 to the fuel tank 18. For example, a start time point t0 and an end time point t1 are shown in FIG. 3. The start time point t0 is a time point at which fuel supply from the fuel supply device 30 to the fuel tank 18 is started. The end time point t1 is a time point at which the fuel supply is completed. As shown in FIG. 3, during a period from the start time point t0 to the end time point t1, the fuel pressure in the second fuel flow path 22 can be maintained at a certain level of pressure higher than the atmospheric pressure.

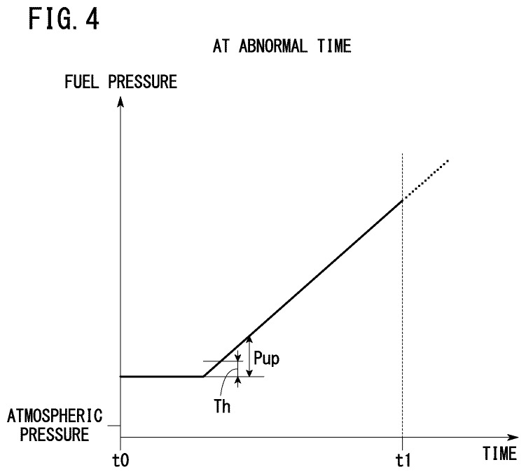

FIG. 4 is a graph showing a change in the fuel pressure in the second fuel flow path 22 in a case where the on-off valve 20 is abnormal. The graph format of FIG. 4 is based on that of FIG. 3.

Even when the closing control signal is output from the on-off valve control unit 44, the on-off valve 20 that is stuck in the open state cannot transition to the closed state in response to the closing control signal. Therefore, after the fuel supply from the fuel supply device 30 to the fuel tank 18 is started, a portion of the fuel supplied to the first fuel flow path 16 leaks to the second fuel flow path 22 via the on-off valve 20. As a result, the fuel pressure in the second fuel flow path 22 excessively increases during the fuel supply from the first fuel flow path 16 to the fuel tank 18. For example, as in FIG. 3, the start time point t0 and the end time point t1 are shown in FIG. 4. When the on-off valve 20 is stuck in the open state, as shown in FIG. 4, the fuel pressure in the second fuel flow path 22 increases during the period from the start time point t0 to the end time point t1. By detecting the increase in the fuel pressure, the determination unit 46 can determine the presence or absence of an abnormality of the on-off valve 20. For example, the determination unit 46 determines that the on-off valve 20 is stuck in the open state in a case where an increase amount Pup of the fuel pressure in the second fuel flow path 22 after the start of the fuel supply to the fuel tank 18 exceeds an increase amount threshold Th determined in advance. The increase amount threshold Th is determined in advance, for example, based on an experiment. The increase amount Pup may be an increase amount of the fuel pressure per unit time.

The determination result by the determination unit 46 can be notified to an owner (driver) of the moving object 10 via, for example, an unillustrated alarm device (a monitor, a lamp, a speaker, or the like) provided in the moving object 10, but the present invention is not limited thereto. For example, the determination result by the determination unit 46 may be transmitted, via a network, to a terminal device such as a smartphone possessed by an administrator who manages the moving object 10. Consequently, the determination result by the determination unit 46 can be notified to the administrator via the terminal device.

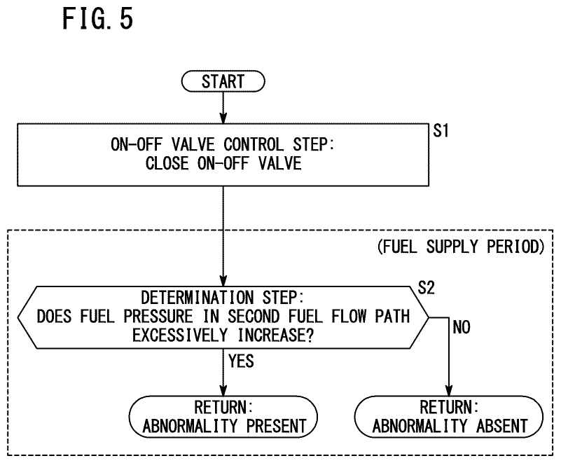

FIG. 5 is a flowchart illustrating an abnormality detection method.

The control device 28 can execute the abnormality detection method of FIG. 5. The abnormality detection method can be executed by the computation unit 40 (the processor) executing a program stored in the storage unit 38 (the memory). The abnormality detection method includes an on-off valve control step S1 and a determination step S2.

The on-off valve control step S1 is started in a case where the fuel is supplied to the fuel tank 18 via the first fuel flow path 16. That is, the on-off valve control step S1 is started, for example, in a case where the filling unit 14 and the nozzle 30n are connected to each other. In the on-off valve control step S1, the on-off valve control unit 44 executes control for closing the on-off valve 20.

Next, the process proceeds to the determination step S2, and the determination unit 46 determines whether or not the fuel pressure in the second fuel flow path 22 excessively increases. The determination step S2 can be executed during a period in which the fuel is supplied to the fuel tank 18 (the fuel supply period in FIG. 5). In the determination step S2, the pressure information acquisition unit 42 sequentially acquires information indicating the pressure in the second fuel flow path 22. The determination unit 46 can determine whether or not the fuel pressure in the second fuel flow path 22 excessively increases, based on the information acquired by the pressure information acquisition unit 42. In a case where the fuel pressure in the second fuel flow path 22 excessively increases (S2: YES), it is determined that there is an abnormality in the on-off valve 20 (RETURN: ABNORMALITY PRESENT). In a case where the fuel pressure in the second fuel flow path 22 does not excessively increase (S2: NO), it is determined that there is no abnormality in the on-off valve 20 (RETURN: ABNORMALITY ABSENT).

In this manner, the abnormality detection method of FIG. 5 is completed. The determination result by the determination unit 46 can be notified to the owner (driver) of the moving object 10 via, for example, the alarm device (not shown) provided in the moving object 10, but the present invention is not limited thereto.

According to the present embodiment, the control device 28 and the abnormality detection method can achieve the following operational effects.

In the present embodiment, the determination unit 46 is caused to determine whether or not the fuel pressure in the second fuel flow path 22 excessively increases in a case where the fuel is being supplied from the first fuel flow path 16 to the fuel tank 18 in a state where the control for closing the on-off valve 20 is being executed. By so doing, it is not necessary to cause the fuel cell system 24 to consume the fuel in order to detect an abnormality of the on-off valve 20. That is, the control device 28 causes the fuel consumption to be suppressed.

In a case where the increase amount Pup of the fuel pressure exceeds the increase amount threshold Th determined in advance, the determination unit 46 determines that there is an abnormality in the on-off valve 20. Thus, only when the fuel pressure changes to a degree significant for the abnormality detection of the on-off valve 20, it is determined that there is an abnormality in the on-off valve 20. Therefore, erroneous detection of abnormality of the on-off valve 20 is suppressed.

Further, as described above, the fuel supply system 12 may include the plurality of check valves 36. The plurality of check valves 36 prevent the fuel from flowing back from the fuel tank 18 toward the first fuel flow path 16. Consequently, in a case where the on-off valve 20 is stuck in the open state, the fuel is more likely to be leaked to the second fuel flow path 22 instead of the first fuel flow path 16. That is, an increase in the fuel pressure in the second fuel flow path 22 due to an abnormality of the on-off valve 20 can be easily detected by the pressure sensor 26.

The fuel supply system 12 may include the second check valve 362 that prevents the fuel from flowing back from the fuel cell system 24 toward the on-off valve 20. Consequently, in a case where the on-off valve 20 is stuck in the open state, the fuel pressure in the second fuel flow path 22 is more likely to increase. As a result, an increase in the fuel pressure in the second fuel flow path 22 due to an abnormality of the on-off valve 20 can be easily detected by the pressure sensor 26.

The second check valve 362 is preferably provided between the on-off valve 20 and the pressure sensor 26. Consequently, in a case where the on-off valve 20 is stuck in the open state, an increase in the fuel pressure in the second fuel flow path 22 can be easily detected by the pressure sensor 26.

The fuel supply system 12 may include the third check valve 363 that prevents the fuel from flowing back from the filling unit 14 toward the fuel supply device 30. Consequently, the fuel supplied to the first fuel flow path 16 can be reliably caused to flow toward the fuel tank 18. As a result, in a case where the on-off valve 20 is stuck in the open state, the fuel is more likely to be leaked to the second fuel flow path 22 instead of the first fuel flow path 16. That is, an increase in the fuel pressure in the second fuel flow path 22 due to an abnormality of the on-off valve 20 can be more easily detected by the pressure sensor 26.

The embodiment may be modified as follows. In the following modifications, the description overlapping with that of the embodiment will be appropriately omitted. Further, in the drawings used in the following modifications, the same components as those described in the embodiment are denoted by the same reference numerals.

### MODIFICATION 1

The control device 28 may include a communication device (not shown), and a signal indicating that the fuel supply device 30 is connected to the filling unit 14 may be transmitted from the fuel supply device 30 to the communication device. In this case, the on-off valve control unit 44 can determine whether or not the fuel supply device 30 is connected to the filling unit 14, based on the signal acquired from the fuel supply device 30. Specifically, based on the signal acquired from the fuel supply device 30, the on-off valve control unit 44 can determine whether or not the fuel supply from the fuel supply device 30 to the fuel tank 18 is started.

The communication method between the fuel supply device 30 and the communication device is, for example, infrared communication, but is not limited thereto.

### MODIFICATION 2

A signal indicating that the fuel supply from the fuel supply device 30 to the moving object 10 (the filling unit 14) is being executed may be transmitted from the fuel supply device 30 to the above-described communication device (see the first modification). In this case, based on the signal acquired from the fuel supply device 30, the determination unit 46 can determine whether or not the fuel is being supplied from the first fuel flow path 16 to the fuel tank 18.

### Combination of Plurality of Modifications

The plurality of modifications described above may be appropriately combined within a range in which no contradiction occurs.

The following supplementary notes are further disclosed in relation to the above-described embodiment.

### Supplementary Note 1

The control device (28) according to the present disclosure is a control device of the fuel supply system (12), the fuel supply system including: the fuel tank (18) configured to store a fuel supplied from the first fuel flow path (16); and the on-off valve (20) provided between the fuel tank and the second fuel flow path (22) configured to supply the fuel to the supply destination system of the fuel that consumes the fuel stored in the fuel tank, the control device including: the on-off valve control unit (44) configured to execute control for closing the on-off valve in a case where the fuel is supplied from the first fuel flow path to the fuel tank; and the determination unit (46) configured to determine presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed. According to this feature, the fuel consumption related to the abnormality detection of the on-off valve is suppressed.

### Supplementary Note 2

In the control device according to supplementary note 1, in a case where the increase amount (Pup) of the pressure exceeds the increase amount threshold (Th) determined in advance, the determination unit may determine that the abnormality is present. According to this feature, erroneous detection of abnormality of the on-off valve is suppressed.

### Supplementary Note 3

The moving object (10) according to the present disclosure includes the control device and the fuel supply system according to supplementary note 1 or 2. According to this feature, the fuel consumption related to the abnormality detection of the on-off valve provided in the moving object is suppressed. As a result, an increase in fuel cost of the moving object can be suppressed.

### Supplementary Note 4

The moving object according to supplementary note 3 may further include the first check valve (361) configured to prevent the fuel from flowing back from the fuel tank toward the first fuel flow path. According to this feature, an increase in the fuel pressure in the second fuel flow path due to an abnormality of the on-off valve can be easily detected by the pressure sensor. The moving object is, for example, a vehicle such as an FCV.

### Supplementary Note 5

The moving object according to supplementary note 3 or 4 may further include the second check valve (362) configured to prevent the fuel from flowing back from the second fuel flow path toward the fuel tank. According to this feature, an increase in the fuel pressure in the second fuel flow path due to an abnormality of the on-off valve can be easily detected by the pressure sensor.

### Supplementary Note 6

The abnormality detection method according to the present disclosure is an abnormality detection method for detecting an abnormality of the fuel supply system (12), the abnormality detection method being executed by a computer, the fuel supply system including: the fuel tank (18) configured to store a fuel supplied from the first fuel flow path (16); and the on-off valve (20) provided between the fuel tank and the second fuel flow path (22) configured to supply the fuel to the supply destination system of the fuel that consumes the fuel stored in the fuel tank, the abnormality detection method including: the on-off valve control step (S1) of executing control for closing the on-off valve in a case where the fuel is supplied from the first fuel flow path to the fuel tank; and the determining step (S2) of determining presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed. According to this feature, the fuel consumption related to the abnormality detection of the on-off valve is suppressed.

### Supplementary Note 7

The program according to the present disclosure is a program for causing the computer to execute the abnormality detection method according to supplementary note 6.

The present invention is not limited to the above disclosure, and various modifications are possible without departing from the essence and gist of the present invention.

1. A control device of a fuel supply system, the control device comprising one or more processors,
the fuel supply system including:
a fuel tank configured to store a fuel supplied from a first fuel flow path; and
an on-off valve provided between the fuel tank and a second fuel flow path configured to supply the fuel to a supply destination system of the fuel that consumes the fuel stored in the fuel tank,
wherein the one or more processors execute computer-executable instructions stored in a memory to cause the control device to:
execute control for closing the on-off valve in a case where the fuel is supplied from the first fuel flow path to the fuel tank; and
determine presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed.

2. The control device according to claim 1, wherein
in a case where an increase amount of the pressure exceeds an increase amount threshold determined in advance, the one or more processors cause the control device to determine that the abnormality is present.

3. A moving object comprising:
the control device according to claim 1; and
the fuel supply system according to claim 1.

4. The moving object according to claim 3, further comprising
a first check valve configured to prevent the fuel from flowing back from the fuel tank toward the first fuel flow path.

5. The moving object according to claim 3, further comprising
a second check valve configured to prevent the fuel from flowing back from the second fuel flow path toward the fuel tank.

6. An abnormality detection method for detecting an abnormality of a fuel supply system, the abnormality detection method being executed by a computer,
the fuel supply system including:
a fuel tank configured to store a fuel supplied from a first fuel flow path; and
an on-off valve provided between the fuel tank and a second fuel flow path configured to supply the fuel to a supply destination system of the fuel that consumes the fuel stored in the fuel tank,
the abnormality detection method comprising:
executing control for closing the on-off valve in a case where the fuel is supplied from the first fuel flow path to the fuel tank; and
determining presence or absence of an abnormality of the on-off valve based on a change in pressure of the fuel in the second fuel flow path, the change in the pressure being obtained when the fuel is being supplied from the first fuel flow path to the fuel tank and the control for closing the on-off valve is being executed.

7. A non-transitory tangible storage medium storing a program for causing the computer to execute the abnormality detection method according to claim 6.
